(19) United States
(12) Patent Application Publication
(10) Pub. No.: US 2016/0208499 A1
(43) Pub. Date: Jul. 21, 2016

(54) System and Method for Manufacture of Artificial Stone Veneer

(71) Applicant: William Gary Bennett, Cumming, GA (US)

(72) Inventor: William Gary Bennett, Cumming, GA (US)

(21) Appl. No.: 15/082,312

(22) Filed: Mar. 28, 2016

Related U.S. Application Data
(63) Continuation-in-part of application No. 13/960,336, filed on Aug. 6, 2013, now abandoned.
(60) Provisional application No. 61/680,626, filed on Aug. 7, 2012.

(51) Int. Cl. E04F 13/14; C04B 28/04; C04B 7/02; E04F 13/08; B28B 1/14

(52) U.S. Cl. CPC E04F 13/147; E04F 13/0873; B28B 1/14; C04B 7/02; C04B 28/04

(57) ABSTRACT

A method and system are described for manufacture of an artificial stone veneer having a lighter weight relative to artificial stones and artificial stone veneers presently known in the art. More specifically, a system and method is described for manufacture of an artificial stone or artificial stone veneer from a cement based compound that includes a portion of crumb rubber. An exemplary compound mixture that may be leveraged by embodiments of the invention comprises: a portion of about 376 pounds of Portland cement, a portion of about 352 pounds of crumb rubber, a portion of reinforcement fibers (cellulose based fiber), a portion of about 192 oz. of accelerator to speed cure time, and a portion of about 32 gallons of water.

### BACKGROUND

Natural stone siding is manufactured from actual stones mined from quarries. The stones are mined in units of large slabs and then processed into smaller forms suitable for application as siding. Processing the stone slabs into smaller forms suitable for use as siding is similar to the manufacture of tiles—the stones are cut with high pressure water and/or diamond saws. Once natural stone is cut into a natural stone siding form, the individual siding pieces may be applied to the exterior of a wall, floor or other supporting surface with mortar.

Natural stone siding can be expensive for simple reason that it's limited in availability.

It's also heavy. Because it's so heavy, it's also expensive to ship. Its weight also dictates that application of the natural stone siding be with mortar onto a solid concrete or block wall substrate. Because of the expense and weight of natural stone siding, there is a demand for “faux stone” and artificial stone veneer.

Faux stone siding uses no actual stones, but is intended to look like actual stones. To create a faux stone, a cement based compound is poured into molds and allowed to set into a stone-like shape. Once formed, each of the “stones” can be set into mortar in much the same way that natural stone is. Some embodiments of faux stone are manufactured in veneer panels that resemble a grouping of natural stones. Artificial stone veneer panels known in the art can also be set into mortar.

Cement based artificial stone known in the art can be a cost effective alternative to natural stone. But, much like natural stone, the weight of the artificial stone makes for expensive shipping costs and limited application. Therefore, what is needed in the art is an artificial stone and/or artificial stone veneer product that is both cost effective in manufacture and shipping as well as versatile in application.

### SUMMARY OF THE DISCLOSURE

A method and system are described for manufacture of an artificial stone veneer having a lighter weight relative to artificial stones and artificial stone veneers presently known in the art. More specifically, a system and method is described for manufacture of an artificial stone or artificial stone veneer from a cement based compound that includes a portion of crumb rubber. Advantageously, because the crumb rubber serves as a filler component in the compound having a relatively lighter weight than the other components comprised within the mixture, the overall per unit weight of an artificial stone veneer made from the compound is lighter than artificial stone veneers presently known in the art. Also, because crumb rubber may be acquired via recycling of tires and other used goods made of rubber, a manufactured stone veneer comprised of a compound that includes crumb rubber provides a positive environmental impact and it is envisioned that some embodiments may be comprised of 85% recycled content by volume.

An exemplary artificial stone veneer product according to an embodiment of the solution comprises a ratio of portions substantially equivalent to a ratio of the following portions: a first portion of Portland cement being about 376 pounds, a second portion of crumb rubber being about 352 pounds, and a third portion of water being about 32 gallons or 276 pounds. An exemplary embodiment may further comprise a portion of reinforcement fibers and/or a portion of an accelerator and/or a portion of a pigment that is operable to impart a color to the artificial stone veneer product.

An exemplary method for manufacture of an artificial stone veneer product according to the solution begins by mixing a volume of compound comprising about 376 pounds of Portland cement, about 352 pounds of crumb rubber, about 32 gallons of water, and reinforcement fibers in an amount adequate to provide structural integrity to the resulting product. Next, the method includes pouring the compound into a mold that forms a relief in the shape of a stone. Then, the method includes allowing the compound to cure in the mold before removing the cured compound from the mold. Advantageously, the cured compound, once removed from the mold, forms an artificial stone veneer product according to an embodiment of the solution. An exemplary embodiment of the method may further comprise applying a pigment to the mold so as to impart a color to the cured compound and/or adding about 192 ounces of accelerator to the compound to affect the curing process.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a high level flow chart outlining a method for manufacture of artificial stone elements or artificial stone veneer elements from a cement based compound that comprises crumb rubber.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the terms “artificial stone,” “artificial stone element,” “artificial stone product,” “artificial stone veneer,” “artificial stone veneer element,” “artificial stone veneer product,” “faux stone” and the like are used interchangeably. As such, the use of any specific one of these terms or the like is not meant to limit the scope of a particular embodiment being described to only the specific term, unless otherwise stated.

In this description, use of the term “embodiment” will indicate to the reader that the particular artificial stone product being described includes one or more novel features attributable to the inventive concept being disclosed.

Artificial stone known in the art is usually made from Portland cement and iron oxide pigments for coloration. Though often lighter than natural stone, some artificial stone known in the art, especially “thick” artificial stone, is heavy enough that it is limited in application to being fixed by mortar to concrete or block wall structures. Other artificial stone veneer or “faux stone” products known in the art are used as an adhered, non-load bearing exterior veneer on non-fire-resistance-rated wood framed or light gage steel stud walls, or concrete masonry walls. Artificial stone veneer products are precast concrete based products made to resemble natural stone in color and in texture. The concrete is comprised of cement, aggregate, water, admixtures and coloring. A typical compound mixture known and used in the industry is:
376 pounds of Portland cement, 270 pounds of sand, 540 pounds of expanded clay, 32 gallons of water

The veneer units are molded and cured and range in thicknesses from ¾″ to 2″. The average saturated weight of the installed artificial stone veneer units does not exceed 15 pounds per square foot.

Embodiments of the invention comprise artificial stone made of a cement based compound that includes a portion of crumb rubber. Because the embodiments leverage such a compound, the artificial stone products produced are relatively light in weight per unit volume. Advantageously, the lighter weight enables embodiments to be fixed to substrates other than concrete or block walls such as, but not limited to, dry wall, gypsum board, plywood, etc via means other than mortar if so desired (such as, but not limited to, thin set, glue, tile/stone adhesive, etc.). Also, certain embodiments that include significant portions of crumb rubber may be cut via means other than wet saws such as, but not limited to, circular saws, scrolls saws, hand saws and the like.

An exemplary compound mixture that may be leveraged by embodiments of the invention comprises:
about 376 pounds of Portland cement, about 352 pounds of crumb rubber, reinforcement fibers (embodiment envisions an amount adequate to provide structural rigidity without negatively affecting appearance of a resulting artificial stone product), about 192 oz. accelerator to speed cure time, about 32 gallons of water (about 267 pounds of water)

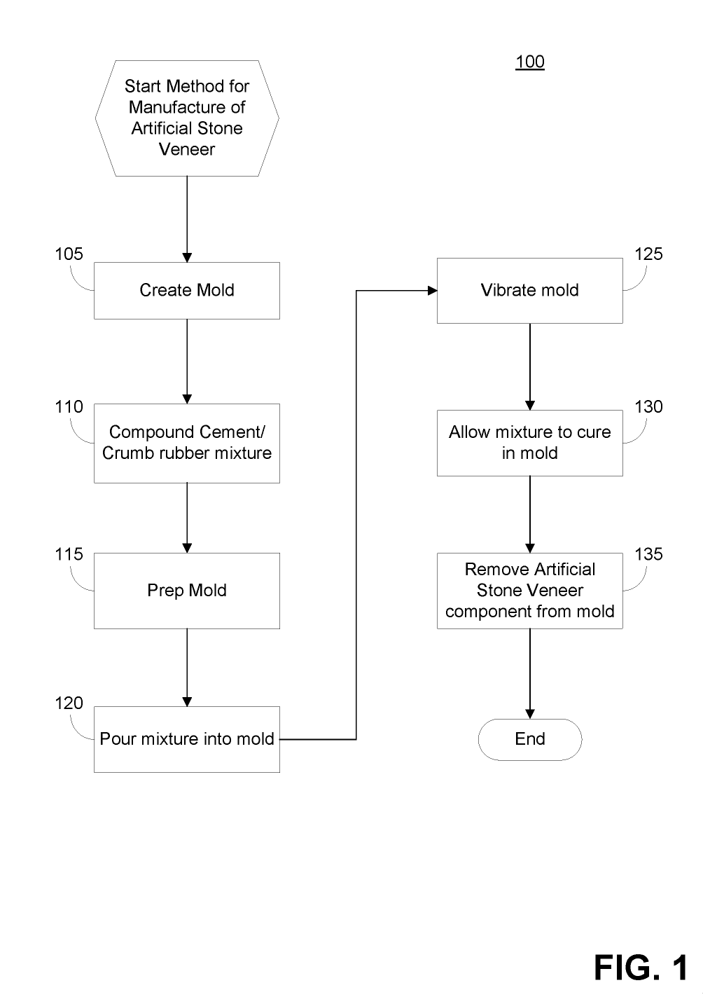

Referring to FIG. 1, depicted is a high level flow chart outlining a method for manufacture of artificial stone elements or artificial stone veneer elements from a cement based compound that comprises crumb rubber. At block 105, as understood in the art, a mold including a hollow form or matrix for giving a particular shape of a natural stone to a formable, curable compound is created. At block 110, a cement based compound that includes a portion of crumb rubber, such as the exemplary compound described above at paragraph [0016], is mixed to a consistency suitable for filling the mold.

At block 115, the mold may be prepped by application of a mold release compound, such as, but not limited to, an oil based compound. At block 115, the mold may also be prepped with iron oxide or other pigments, including powder based pigments, as is known in the art. By applying pigments to the mold prior to introduction of a mixture, one of ordinary skill in the art will recognize that colors and shades resembling natural stone may be imparted to an artificial stone product. Notably, it is envisioned that some embodiments may leverage a compound comprising colorant such that the color extends throughout the artificial stone product.

At block 120, the cement based compound that includes crumb rubber is poured into the mold and at block 125 the mold is vibrated to remove air pockets and settle the compound into the various reliefs included in the mold. At block 130, the compound is allowed to cure in the mold. It is envisioned that some embodiments may benefit from an expedited cure process resulting from inclusion of an accelerator component in the cement based compound that includes crumb rubber. It is also envisioned that some embodiments may be cured via introduction of a heat source, vacuum source, etc.

At block 135, a cured or hardened artificial stone veneer product according to an embodiment of the invention may be removed from the mold.

Certain steps or blocks in the processes or process flows described in this specification naturally precede others for the invention to function as described. However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Also, in some instances, multiple actions depicted and described as unique steps or blocks in the present disclosure may be comprised within a single step or block. Further, words such as “thereafter”, “then”, “next”, “subsequently”, etc. are not intended to limit the order of the steps or blocks. These words are simply used to guide the reader through the description of the exemplary method.

Therefore, although selected aspects have been illustrated and described in detail, it will be understood that various substitutions and alterations may be made therein without departing from the spirit and scope of the present invention, as defined by the following claims.

What is claimed is:

1. An artificial stone veneer product comprising a ratio of portions substantially equivalent to a ratio of the following portions:
a first portion of Portland cement being about 376 pounds;
a second portion of crumb rubber being about 352 pounds;
a third portion of water being about 267 pounds; and
a fourth portion of reinforcement fibers.

2. The artificial stone veneer product of claim 1, further comprising:
a fifth portion of an accelerator.

3. The artificial stone veneer product of claim 1, further comprising:
a fifth portion of a pigment, wherein the pigment operates to impart a color to the artificial stone veneer product.

4. An artificial stone veneer product comprising a ratio of portions substantially equivalent to a ratio of the following portions:
a first portion of Portland cement being about 376 pounds;
a second portion of crumb rubber being about 352 pounds;
a third portion of water being about 32 gallons; and
a fourth portion of reinforcement fibers.

5. The artificial stone veneer product of claim 4, further comprising:
a fifth portion of an accelerator.

6. The artificial stone veneer product of claim 4, further comprising:
a fifth portion of a pigment, wherein the pigment operates to impart a color to the artificial stone veneer product.

7. A method for manufacture of an artificial stone veneer product, the method comprising:
mixing a volume of compound, the compound comprising:
about 376 pounds of Portland cement;
about 352 pounds of crumb rubber;
about 32 gallons of water; and
reinforcement fibers;
pouring the compound into a mold, wherein the mold forms a relief in the shape of a stone;
allowing the compound to cure in the mold; and
removing the cured compound from the mold, wherein the cured compound forms an artificial stone veneer product.

8. The method of claim 7, further comprising:
applying a pigment to the mold, wherein the pigment operates to impart a color to the cured compound.

9. The method of claim 7, wherein the compound further comprises:
about 192 ounces of accelerator.
